(19) United States
(12) Patent Application Publication
(10) Pub. No.: US 2026/0094102 A1
(43) Pub. Date: Apr. 2, 2026

(54) ITEM-LEVEL PRESCRIPTIVE RECOMMENDATIONS

(71) Applicant: NCR Voyix Corporation, Atlanta, GA (US)

(72) Inventors: Shiran Abadi, Tel-Aviv (IL); Tamar Miriam Haizler, Kfar-Saba (IL); Itamar David Laserson, Givat Shmuel (IL)

(21) Appl. No.: 18/902,510

(22) Filed: Sep. 30, 2024

(51) Int. Cl. G06Q 10/0639; G06Q 10/0637; G06Q 10/087; G06Q 30/0207

(52) U.S. Cl. CPC G06Q 10/06393; G06Q 10/06375; G06Q 10/087; G06Q 30/0223

(57) ABSTRACT

Underperforming items in retail stores are identified by comparing item sales data across similar stores. Similar stores are identified based on total item sales and item catalog sizes. Departments that can be optimized are identified. Item sales within selected departments are compared and undersold items are identified using specific criteria. In an embodiment, undersold items are determined as item sales that have less than half the average sales amount in similar stores and that meet a minimum sales threshold in the similar stores. A data-driven approach is employed to detect underperforming items without requiring complex machine learning models or tiresome exploration in reports and dashboards. Results are presented to users, showing proposed items with observed and expected sales data, enabling store managers to make informed decisions for improving the performance of their departments.

### BACKGROUND

Store operations managers face significant challenges in effectively identifying weak points in their operations and taking appropriate steps to resolve them. The primary obstacle is a lack of time and expertise to thoroughly analyze data, identify causal factors, and correctly set new targets for improvement. This is particularly evident in sales performance, where managers struggle to pinpoint underperforming items or departments within their stores. Traditional methods rely on manual exploration of dashboards and reports, which is time-consuming, labor-intensive, and often based on intuition rather than data-driven insights. This approach limits the ability to effectively improve performance across large retail organizations, especially when dealing with the complexities of comparing performance across multiple stores and departments.

### BRIEF DESCRIPTION OF THE DRAWINGS

FIG. 1 is a diagram of a system for item-level prescriptive recommendations, according to an example embodiment.

FIG. 2 is a flow diagram of a method for item-level prescriptive recommendations, according to an example embodiment.

FIG. 3 is a flow diagram of another method for item-level prescriptive recommendations, according to an example embodiment.

### DETAILED DESCRIPTION

Retail store operations face significant challenges in identifying and addressing underperforming areas within their businesses. One of the most critical metrics for in store sales is department performance, as some departments can account for up to 30% of total store sales. While suggesting an increase in department sales by a certain percentage is a common approach, it lacks actionability as it does not provide specific information on how to achieve that increase.

Embodiments presented herein address this problem by proposing a data-driven process that suggests achievable and measurable targets to increase item sales for each store. This approach also addresses numerous existing challenges, which include:
1. Departments that can have thousands of items with different characteristics, some seasonal and some retired. Looking at item movement alone does not provide a complete picture of potential sales.
2. Comparing item movement between stores requires caution due to variations such as different suppliers/vendors and store sizes.
3. A purely statistical approach to find significant differences in item performance is not suitable, as a goal is to identify a group of items that collectively impact the department's sales, rather than a single item.

To overcome these challenges, embodiments provided herein employ a novel method that includes the following:
1. For each store, identify similar stores based on total sales amount and catalog sizes, ensuring comparisons are made between stores with similar characteristics.
2. Utilization of a prescriptive recommendations model to determine which departments can be optimized for each store.
3. For a given store and department, compare the sales amount and count of each item to similar stores, focusing on items that are undersold vis-à-vis other stores.
4. Employ specific criteria to identify undersold items, such as item sales having less than half the average sales amount in similar stores and meeting a minimum sales threshold in other stores.

This approach provides store managers with actionable insights by identifying specific items within departments that are underperforming compared to similar stores. By focusing on item-level recommendations, the embodiments presented herein provide more targeted and effective strategies for improving department and overall store sales performance.

Furthermore, the approach is designed to be lightweight in terms of computational performance, not requiring the training of complex machine learning models. Instead, the approach relies on data-driven comparisons and analysis, allowing for quick computation of results based on past transactional data. This makes the approach more accessible and easier to implement across various retail environments.

By providing store managers with specific, data-driven recommendations at the item level, embodiments herein address the need for more actionable insights in retail operations. It enables managers to make informed decisions about which items to promote or focus on within underperforming departments, ultimately leading to improved sales performance and more efficient store operations.

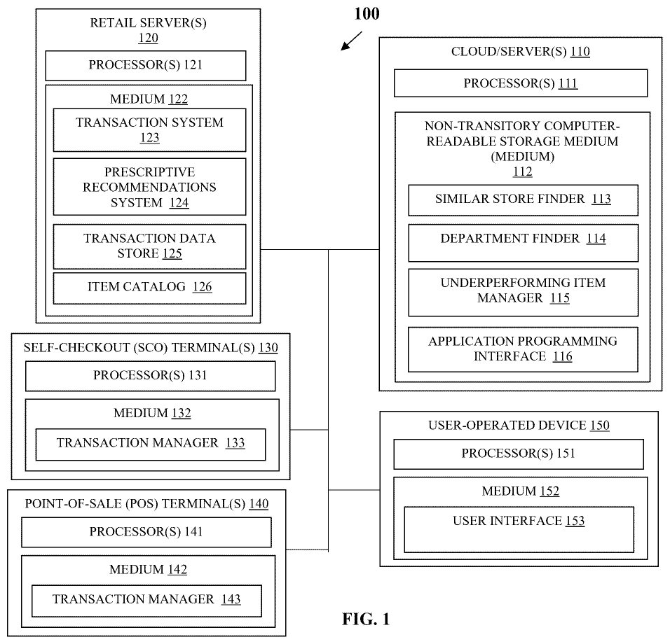

FIG. 1 is a diagram of a system 100 for item-level prescriptive recommendations, according to an example embodiment. Notably, the components are shown schematically in simplified form, with only those components relevant to understanding of the embodiments being illustrated.

Furthermore, the various components (that are identified in system 100) are illustrated and the arrangement of the components are presented for purposes of illustration only. Notably, other arrangements with more or less components are possible without departing from the teachings of item-level prescriptive recommendations, presented herein and below.

System 100 includes a cloud/server 110 (hereinafter “cloud 110”), one or more retail servers 120, SCO terminals 130, POS terminals 140, and one or more user-operated devices 150. Cloud 110 includes at least one processor 111 and a non-transitory computer-readable storage medium (hereinafter “medium”) 112, which includes instructions for a similar store finder 113, a department finder 114, an underperforming item manager 115, an application programming interface (API) 116. The instructions when executed by processor 111 cause processor 111 to perform processing or operations discussed herein and below with respect to 113-116.

Each retail server 120 includes at least one processor 121 and a medium 122, which includes instructions for a transaction system 123 and an optional prescriptive recommendations system 124. The instructions when executed by processor 121 cause processor 121 to perform processing and operations discussed herein and below with respect to 123-124. Medium 122 also includes a transaction data store 125 and an item catalog 126.

Each SCO terminal 130 includes at least one processor 131 and a medium 132, which includes instructions for a transaction manager 133. The instructions when executed by processor 131 cause processor 131 to perform processing and operations discussed herein and below with respect to 133.

Each POS terminal 140 includes at least one processor 141 and a medium 142, which includes instructions for a transaction manager 143. The instructions when executed by processor 141 cause processor 141 to perform processing and operations discussed herein and below with respect to 143.

Each user-operated device 150 includes at least one processor 151 and a medium 152, which includes instructions for a user interface 153. The instructions when provided to and executed by processor 151 cause processor 151 to perform the processing or operations discussed herein and below with respect to 153.

Initially, similar store finder 113 uses transaction data stores 125 and item catalogs of retail servers 120 of retailers to cluster or associate similar stores of the retailers into groups of similar stores. This is an apples to apples comparison that avoids comparing small stores to large stores solely based on monetary revenues of the store.

In an embodiment, similar store finder 113 starts with a target store from a pool of available stores and compares a total sales of the target store to sales of each of the available stores. When the total sales obtained from corresponding transaction data stores 125 are less than approximately plus or minus 20% between the target store and an available store being evaluated and when the total unique items obtained from corresponding item catalogs 126 are less than approximately plus or minus 20% between the target store and an available store being evaluated, the similar store finder 113 flags the available store as being a similar store to the target store.

In an embodiment, the similar store finder 113 uses predefined criteria for grouping the stores into similar stores or clusters. The predefined criteria can be customized based on metrics associated with store demographic characteristics, store geographic locations, store types, etc.

In an embodiment, the similar store finder 113 employs a k-means clustering algorithm utilizing a variety of metrics associated with sales, catalog sizes, demographics, geographic locations, store types, etc. The K-means clustering algorithm provides the similar stores as clustered or grouped stores as output to similar store finder.

Optionally, once the stores are grouped into similar stores, department finder 114 identifies one or more departments within a target store that can be optimized. In an embodiment, the department store finder 114 identifies the departments, which can be optimized, based on output provided by a given retailer's prescriptive recommendations system 124. In an embodiment, a prescriptive recommendations machine learning model of the prescriptive recommendations system 124 provides department identifiers for a target store that can be optimized based on an analysis of sales key performance indicators (KPIs) for the departments. The department finder 114 provides the one or more department identifiers provided by the prescriptive recommendations machine learning model to the underperforming item manager 115 for further evaluation.

In an embodiment, department finder 114 utilizes each department of a target store as a potential department that can be optimized. In this embodiment, department finder 114 provides each department identifier for each known department of a target store to underperforming item manager 115 for further evaluation.

Underperforming item manager 115, compares the total item sales amounts and item counts of each item for a given department of a target store against corresponding data for each of the target store's similar stores. The goal is to find items within each department of the target store that are undersold relative to the similar stores for the target store. A purely statistical approach is not effective because the data is too noisy to obtain a significant distinction, since there are too many items being compared between multiple stores. As a result, underperforming item manager 115, compares item sales of each item to find items of each department of the target store which were sold much less than the similar stores while also ensuring that corresponding item sales in the similar stores were not negligible.

As a result, underperforming item manager 115 analyzes item sales data for each department of the target store using a set of criteria. For example, underperforming item manager 115 averages a given item's sales across the similar stores and ensures that item sales for the department of the target store is less than half the average item sales for the similar stores as a whole. The underperforming item manager 115 also ensures that item sales for the item in each of the similar stores are above a threshold amount (e.g., above $100) and/or above a threshold percentage of a given store's total sales amount. In an embodiment, the threshold dollar amount and/or threshold sales percentage for determining negligibility depends on sales traffic in the similar stores and a time window for the sales traffic. Thus, the threshold dollar amount and/or threshold sales percentage changes over time and is configurable.

Because the number of similar stores relative to a target store being analyzed can be large, the average sales amount per item for the similar stores can be interpreted as an expected item sales amount for a given department of the target store. The average sales being interpreted as the expected sales does not depend on the number of similar stores. In addition, store manager should know techniques for improving the item sales of a given item within a given department of the target store. The known techniques can include promotions for the item, changing the item's placement to make it more visible within the department, bundling the item with other items in promoted basked of items, etc.

In an embodiment, the underperforming item manager 115 links a list of known techniques to a given item identifier for an underperforming item to provide actionable recommendations. In an embodiment, the underperforming item manager 115 uses a knowledge based of the retail which may include item-specific actions to increase sales of a given item and links corresponding item-specific actions to each identified underperforming item.

The underperforming item manager 115 provides a list of underperforming items by department and by store via API 116 to a user interface 153 of a user-operated device 150. In an embodiment, the user interface includes an interface option or link by store and by department of store. When the user selects the option or link, the user is presented with a list of each underperforming item by department within a given store. The list includes current item sales for the department and expected item sales that the department can expect to realize if actionable recommendations are employed within the department.

In an embodiment, underperforming item manager 115 uses API 116 to integrate notification and data relevant to underperforming items into existing services of a retailer. For example, underperforming item manager 115 provides store identifiers, department identifiers, underperforming item identifiers, expected item sales, and/or actionable recommendations to existing services associated with an existing prescriptive recommendations system 124 of the retailer. In another example, the underperforming item manager 115 provides department identifiers, underperforming item identifiers, expected item sales, and/or actionable recommendations to an existing dashboard service of the retailer such that the information is presented to the users on the user-operated devices 150 withing a dashboard interface.

Transaction system 123 maintains the transaction data store 125 based on transactions processed by transaction managers 133 of self-checkout (SCO) terminals 130 and point-of-sale (POS) terminals 140. Furthermore, transaction system 123 processes transaction originating online via web-based store portals. Transaction system 123 updates the transaction data store accordingly based on transaction processed on the SCO terminals 130, the POS terminals 140, and the web-based store portals.

In an embodiment, underperforming item manager 115 processes at a preconfigured interval of time using a given last interval of transactions updated to a corresponding transaction data store 125 for a given retailer and/or a given store of the retailer. In an embodiment, underperforming item manager 115 is processed on demand based on an option selected by a user through user interface 153 and a user provided given interval of transactions. In an embodiment, the preconfigured interval of time and the interval of transactions is configurable via a configuration parameter and/or via a processing parameter.

Existing approaches to identify underperforming items rely on time series and item sales forecasts using transaction histories for the items. System 100 does not rely the item sales movement but rather learns from and leverages positive item sales of departments in similar stores.

A purely statistical approach seems intuitive for finding underperforming items but such approach is not feasible due to the typically large number of items to compare, which introduce noise and statistical ambiguity. System 100 finds multiple items that collectively make a difference for an entire department without forcing any given item to be a significant difference.

System 100 is flexible allowing the finding of similar stores based on a configurable designated context (e.g., monetary, geography, demographics, store types, or a combination of these characteristics). System 100 is also lightweight in terms of computational resources and response times (i.e., lightweight computational performance). System 100 does not require and is implemented without training any machine learning model/algorithm. Underperforming items are quickly identified on demand using any provided past transactional data of a given interval of time. Furthermore, system 100 is fully integrated into existing systems, existing services, existing interfaces, and user interface 153 via API 116 ensuring that store personnel know in real time or near real time their underperforming items within their departments along with expected or anticipated item sales for those items if actional recommendations are employed.

System 100 is data driven by leveraging data associated with similar stores that are experiencing satisfactory or better item sales. Underperforming items are rapidly identified and communicated to store personnel in minutes or less. Conversely, conventional approaches rely on business intelligence and business experts that manually explore dashboards and reports to track how stores can improve item sales. The sheer volume of items in existing item catalogs make the conventional approaches unrealistic because manual review is nearly impossible. As a result, system 100 saves time and labor of retailers by driving automation. System 100 is also particularly beneficial in a growing competitive landscape experiencing a labor crisis.

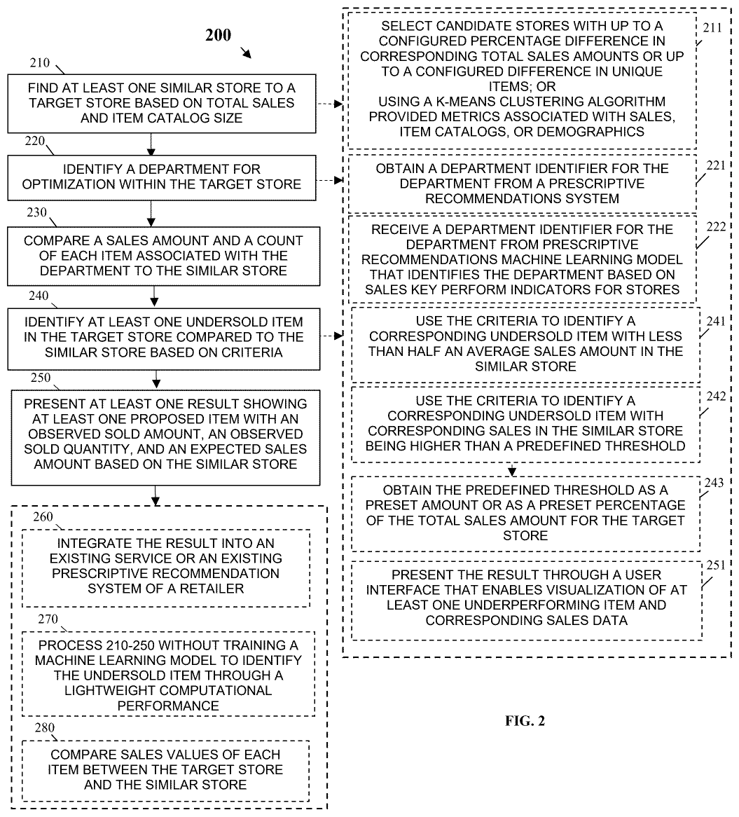

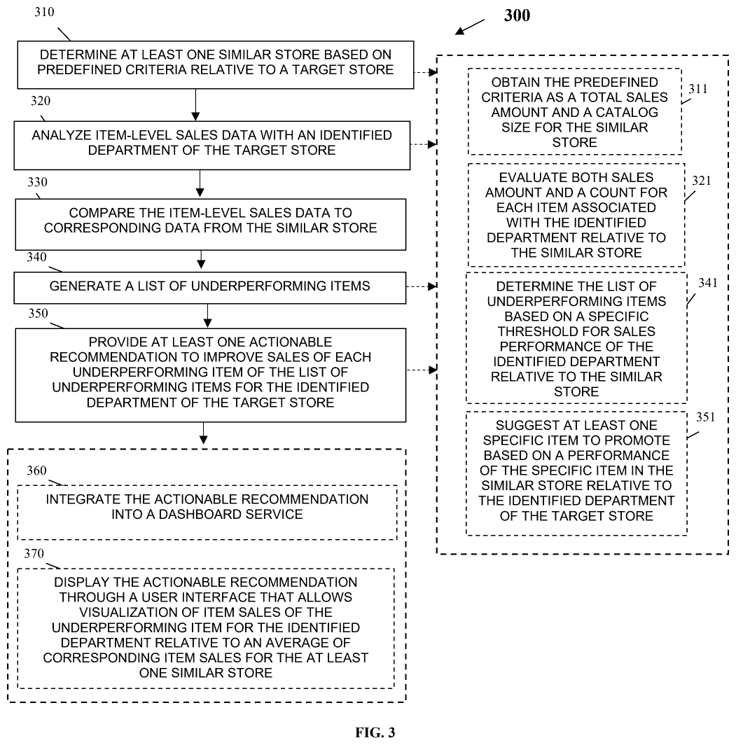

The above-referenced embodiments and other embodiments are now discussed with reference to FIGS. 2 and 3. FIG. 2 is a flow diagram of a method 200 for item-level prescriptive recommendations, according to an example embodiment. The software module(s) that implements the method 200 is referred to as an “item-level recommender.” The item-level recommender is implemented as executable instructions programmed and residing within memory and/or a non-transitory computer-readable (processor-readable) storage medium and executed by one or more processors of one or more devices. The processor(s) of the device(s) that executes the item-level recommender are specifically configured and programmed to process the item-level recommender. The item-level recommender may have access to one or more network connections during its processing. The network connections can be wired, wireless, or a combination of wired and wireless.

In an embodiment, the device that executes the item-level recommender is cloud 110. In an embodiment, the device that executes the item-level recommender is retail server 120. In an embodiment, the item-level recommender is any combination of or all of similar store finder 113, department finder 114, underperforming item manager 115, and API 116.

At 210, item-level recommender finds at least one similar store to a target store based on total sales and item catalog size. In an embodiment, at 211, the item-level recommender selects candidate stores with up to a configured percentage difference in corresponding total sales amounts up or up to a configured difference in unique items identified in corresponding catalogs. In an embodiment, of 211, item-level recommender uses a k-means clustering algorithm that is provided metrics associated with sales, item catalogs, or demographics.

At 220, the item-level recommender identifies a department for optimization within the target store. In an embodiment, at 221, the item-level recommender obtains a department identifier for the department from a prescriptive recommendations system 124. In an embodiment, at 222, the item-level recommender receives a department identifier for the department from a prescriptive recommendations machine learning model that identifies the department based on sales key performance indicators (KPIs) for retail stores.

At 230, the item-level recommender compares a sales amount and a count of each unique item associated with the department to the similar store. At 240, the item-level recommender identifies at least one undersold item in the target store compared to the similar store based on criteria.

In an embodiment, at 241, the item-level recommender uses the criteria to identify a corresponding undersold item with less than half an average sales amount in the similar stores. In an embodiment, at 242, the item-level recommender uses the criteria to identify a corresponding undersold item with corresponding sales in the similar store being higher than a predefined threshold. In an embodiment, of 242 and at 243, the item-level recommender obtains the predefined threshold as a preset amount or as a preset percentage of the total sales amount for the target store.

In an embodiment, at 250, the item-level recommender presents at least one result showing at least one proposed item with an observed sold amount, an observed sold quantity, and an expected sales amount based on the similar store. In an embodiment, at 251, the item-level recommender presents the result through a user interface 153. The user interface 153 enables visualization of at least one underperforming item and corresponding sales data.

In an embodiment, at 260, the item-level recommender integrates the result into an existing service of an existing prescriptive recommendations system of a retailer. In an embodiment, at 270, the item-level recommender (i.e., 210-250) is processed without requiring training of a machine learning model to identify the undersold item through lightweight computational performance. In an embodiment, at 280, the item-level recommender compares sales values of each item between the target store and the similar store(s).

FIG. 3 is a diagram of another method 300 for item-level prescriptive recommendations, according to an example embodiment. The software module(s) that implements the method 300 is referred to as an “underperforming item manager.” The underperforming item manager is implemented as executable instructions programmed and residing within memory and/or a non-transitory computer-readable (processor-readable) storage medium and executed by one or more processors of one or more device(s). The processors that execute the underperforming item manager are specifically configured and programmed for processing the underperforming item manager. The underperforming item manager may have access to one or more network connections during its processing. The network connections can be wired, wireless, or a combination of wired and wireless.

In an embodiment, the device that executes underperforming item manager is cloud 110. In an embodiment, the device that executes the underperforming item manager is retail server 120. In an embodiment, the underperforming item manager is any combination of or all of similar store finder 113, department finder 114, underperforming item manager 115, API 116, and/or method 200. The underperforming item manager presents another and, in some ways, enhanced processing perspective from that which was discussed above for the system 100 of FIG. 1 and/or method 200 of FIG. 2.

At 310, the underperforming item manager determines at least one similar store based on predefined criteria relative to a target store. In an embodiment, at 311, the underperforming item manager obtains the predefined criteria as a total sales amount and a catalog size for the similar store(s).

At 320, the underperforming item manager analyzes item-level sales data with an identified department of the target store. The department is identified based on sales KPIs indicating that the department is capable of being optimized based on one or more of the departments sales KPIs. In an embodiment, at 321, the underperforming item manager evaluates both sales amount and a count for each unique item associated with the identified department relative to the similar store(s).

At 330, the underperforming item manager compares the item-level sales data to corresponding data from the similar store(s). At 340, the underperforming item manager generates a list of underperforming items based on 330. In an embodiment, at 341, the underperforming item manager determines the list of underperforming items based on a specific threshold for sales performance of the identified department relative to the similar store(s).

At 350, the underperforming item manager provides at least one actionable recommendation to improve sales of each underperforming item of the list of underperforming items for the identified department of the target store. In an embodiment, at 351, the underperforming item manager suggests at least one specific item to promote based on a performance of the specific item in the similar store relative to the identified department of the target store.

In an embodiment, at 360, the underperforming item manager integrates the actionable recommendation into a dashboard service or dashboard interface of an existing service via API 116. In an embodiment, at 370, the underperforming item manager displays the actionable recommendation through a user interface 153 that allows visualization of item sales of the underperforming item for the identified department relative to an average of corresponding item sales for the similar store(s).

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method comprising:
finding at least one similar store to a target store based on total sales amount and item catalog size;
identifying a department for optimization within the target store;
comparing a sales amount and a count of each item associated with the department to the at least one similar store;
identifying at least one undersold item in the target store compared to the at least one similar store based on criteria; and
presenting at least one result showing at least one proposed item with an observed sold amount, an observed sold quantity, and an expected sales amount based on the at least one similar store.

2. The method of claim 1, wherein finding the at least one similar store comprises:
selecting candidate stores with up to a configured percentage difference in corresponding total sales amounts or up to a configured percentage difference in unique items sold; or
using a k-means clustering algorithm provided metrics associated with sales, item catalogs, or demographics.

3. The method of claim 1, wherein identifying the department further includes obtaining a department identifier for the department from a prescriptive recommendations machine learning model.

4. The method of claim 1, wherein identifying the department further includes receiving a department identifier for the department as output from an existing prescriptive recommendations model that identifies the department based on sales key performance indicators (KPIs) for retail stores.

5. The method of claim 1, wherein identifying the at least one undersold item further includes using the criteria to identify a corresponding undersold item with less than half an average sales amount in the at least one similar store.

6. The method of claim 1, wherein identifying the at least one undersold item further includes using the criteria to identify a corresponding undersold item with corresponding sales in the at least one similar store being higher than a predefined threshold.

7. The method of claim 6, wherein using further includes obtaining the predefined threshold as a preset amount or as a preset percentage of the total sales amount for the target store.

8. The method of claim 1, wherein presenting further includes presenting the at least one result through a user interface that enables visualization of at least one underperforming item and corresponding sales data.

9. The method of claim 1, further comprising integrating the at least one result into an existing service or an existing prescriptive recommendations system of a retailer.

10. The method of claim 1, further comprising processing the method without training a machine learning model to identify the at least one undersold item through lightweight computational performance.

11. The method of claim 1, further comprising comparing sales values of each item between the target store and the at least one similar store.

12. A method comprising:
determining at least one similar store based on predefined criteria relative to a target store;
analyzing item-level sales data within an identified department of the target store;
comparing the item-level sales data to corresponding data from at the at least one similar store;
generating a list of underperforming items; and
providing at least one actionable recommendation to improve sales of each underperforming item of the list of underperforming items for the identified department of the target store.

13. The method of claim 12, wherein determining further include obtaining the predefined criteria as a total sales amount and a catalog size for the at least one similar store.

14. The method of claim 12, wherein analyzing furthers include evaluating both sales amount and a count for each item associated with the identified department relative to the at least one similar store.

15. The method of claim 12, wherein generating further includes determining the list of underperforming items based on a specific threshold for sales performance of the identified department relative to the at least one similar store.

16. The method of claim 12, wherein providing further includes suggesting at least one specific item to promote based on a performance of the at least one specific item in the at least one similar store relative to the identified department of the target store.

17. The method of claim 12, further comprising integrating the at least one actionable recommendation into a dashboard interface.

18. The method of claim 12, further comprising displaying the at least one actionable recommendation through a user interface that allows visualization of item sales of at least one underperforming item of the identified department relative to an average of corresponding item sales for the at least one similar store.

19. A system comprising:
a processor configured to:
identify at least one similar store relative to a target store based on predefined criteria;
determine a department within the target store for optimization;
compare item-level sales data within the department to corresponding data from the at least one similar store; and
identify at least one underperforming item of the department based on specific comparison criteria; and
a user interface configured to display item-level sales data for the at least one underperforming item of the department within the target store relative to corresponding item-level sales data of the at least one similar store.

20. The system of claim 19,
wherein the processor is further configured to:
provide at least one actionable recommendation for the at least one underperforming item to the user interface;
wherein the user interface is further configured to:
present the at least one actionable recommendation with the item-level sales data for the at least one underperforming item.
